(19) United States
(12) Patent Application Publication
(10) Pub. No.: US 2004/0247390 A1
(43) Pub. Date: Dec. 9, 2004

(54) Construction device and method stamping concrete

(76) Inventor: Aaron D. Smith, Norwalk, OH (US)

Correspondence Address: MYERS & KAPLAN, INTELLECTUAL PROPERTY LAW, L.L.C., 1899 POWERS FERRY ROAD, SUITE 310, ATLANTA, GA, 30339, US

(21) Appl. No.: 10/452,219

(22) Filed: Jun. 3, 2003

(51) Int. Cl. B28B 3/12

(52) U.S. Cl. 404/93; 425/471

(57) ABSTRACT

The invention comprises a machine and method for embossing construction surfaces where the machine has a patterned belt, such that the pattern does not repeat for a distance adequate to prevent the appearance of repetition, and further includes a facility for supplying release agent and a brush means for removing debris from the belt.

### TECHNICAL FIELD

The present invention relates generally to an apparatus and method for creating an impression in concrete or other construction surfaces for effectuating a visually non-repetitive pattern.

### BACKGROUND OF THE INVENTION

Concrete and other construction surfaces are often employed with both functional and decorative aspects. Texturing of these surfaces is carried out while in the plastic condition by a variety of means, most typically by hand stamping of an impression with a mat before the material takes a set. Other means, such as a roller device having an embossed surface, may be utilized to create similar patterns with less effort. However, two major drawbacks to the texturing methods currently employed is that their patterns have visible repetition because the spacing between impressions is only of a distance defined by the length of the mat or the circumference of the roller, and they are labor intensive.

Although various devices and methods are known, all are disadvantageous when compared to the present invention:

Rolling devices for impressing concrete are well known. U.S. Pat. No. 324,166 to Riordan teaches a hand-guided, man-powered rolling device. U.S. Pat. No. 519,919 to Maurer teaches a hand roller for ornamenting pavement surfaces having its pattern on the surface of a roll. U.S. Pat. No. 993,086 to Malloy teaches a hand-guided, man-powered roller device having a pattern on the surface of a roll for applying a texture to street materials that have not yet solidified. U.S. Pat. No. 3,910,738 to Chandler et al. teaches a hand-guided or powered concrete finishing roller having a pattern on its surface for applying an impression to concrete. U.S. Pat. No. 5,228,799 to Sondreal teaches a roller for making impressions in concrete, wherein the roller is pulled and guided by persons on either side. All of these devices suffer from the same disadvantage in that the pattern they form is clearly repetitive to the observer.

Other methods have been attempted to cover larger surface areas. For instance, U.S. Pat. No. 967,714 to Blome et al. teaches a pavement-blocking machine that traverses a frame and periodically stamps a pattern into the concrete. This device is overly complicated and requires set up and tear down to move to a new position.

U.S. Pat. No. 5,038,714 to Dye et al. and U.S. Pat. No. 5,061,172 to Fennessey, Sr. are examples of tools that impart an impression to concrete by pressing the tool into the concrete surface. U.S. Pat. No. 4,135,840 to Puccini et al. purports to imprint a non-repeating pattern in concrete, wherein the tool is placed on the concrete and pressed down to form the pattern. However, all of these are unsuitable for continuous use, and must be picked up and moved to create each sequential portion of the pattern.

While some or all of the above-referenced patents may be utilized for embossing concrete or other plastic construction surfacing materials, they fail to adequately provide the appearance of a non-repeating pattern and/or are labor intensive in application.

Accordingly, there is a need for a device and method that permits an extensive surface area to be covered without repetition of the pattern for a distance that establishes an aesthetic pattern non-repetitive to the visual observer.

### BRIEF SUMMARY OF THE INVENTION

Briefly described, in a preferred embodiment, the present invention overcomes the above-mentioned disadvantages and meets the recognized need for such a device by providing a method and apparatus for creating a textured surface on concrete or other plastic surfacing materials that does not give the appearance of repeating.

According to its major aspects and broadly stated, the present invention in its preferred embodiment is a machine, and method of use thereof, having a belt of sufficient length that when a pattern is applied by rotation of the belt across a surface, the pattern does not appear to repeat.

More specifically, the present invention is a surfacing machine, and method of use thereof, that may be used to create an impression on concrete or other plastic construction surfaces by means of a patterned belt, festooned within the machine, thus providing an adequate length of belt to extend the periodicity of repetition to a length of approximately twenty feet, thus rendering the repetition indiscernible to the human eye.

A feature and advantage of the present invention is its ability to create a patterned surface on concrete or other plastic construction materials to reduce the appearance of repeating.

A further feature and advantage of the present invention is that it is suitable for creating a texture on horizontal surfaces.

A feature and advantage of the present invention is that it is suitable for texturing vertical or sloping surfaces, particularly on walls.

A further feature and advantage of the present invention is that it can be internally powered, manually powered, or driven from a parent apparatus, such as a paving machine.

A feature and advantage of the present invention is that it can be connected to other similar machines to create a wider pattern or a pattern covering differing planes.

These and other objects, features and advantages of the present invention will become more apparent to one skilled in the art from the following description and claims when read in light of the accompanying drawings.

### BRIEF DESCRIPTION OF THE DRAWINGS

Having thus described the invention in general terms, the present invention will be better understood by reading the Detailed Description of the Preferred and Alternate Embodiments with reference to the accompanying drawing figures, which are not necessarily drawn to scale, and in which like reference numerals denote similar structures and refer to like elements throughout, and in which:

FIG. 1 is a perspective view of a device according to a preferred embodiment of the present invention shown in operation.

FIG. 2 is a cross-sectional view of the drive component of a device according to a preferred embodiment of the present invention.

FIG. 3 is a perspective cutaway view of a side of a device according to a preferred embodiment of the present invention.

FIG. 4 is a side cross-sectional view of the device of FIG. 3.

FIG. 5 is a partial cutaway perspective view of a device according to a preferred embodiment of the present invention.

FIG. 6 is a cutaway perspective view of an alternate embodiment of the present invention shown in operation.

FIG. 7 is a front view of the alternate embodiment of the present invention shown in FIG. 6.

FIG. 8 is a cutaway view of the alternate embodiment of the present invention shown in FIGS. 6 and 7.

FIG. 9 is a side plan view of an alternate embodiment of the present invention.

### DETAILED DESCRIPTION OF THE PREFERRED AND ALTERNATIVE EMBODIMENTS

In describing the preferred and selected alternate embodiments of the present invention, as illustrated in the Figures, specific terminology is employed for the sake of clarity. The invention, however, is not intended to be limited to the specific terminology so selected, and it is to be understood that each specific element includes all technical equivalents that operate in a similar manner to accomplish similar functions.

The present invention is suitable for applying a pattern to concrete or other plastic materials, such that the pattern does not repeat for a substantial distance, thereby providing the appearance of a non-repeating pattern.

The present invention can further be adapted for use in larger constructions and for both vertical and horizontal applications. Multiple units of the present invention can be ganged together or fabricated as a whole to provide the ability to apply patterns in multiple dimensions or planes.

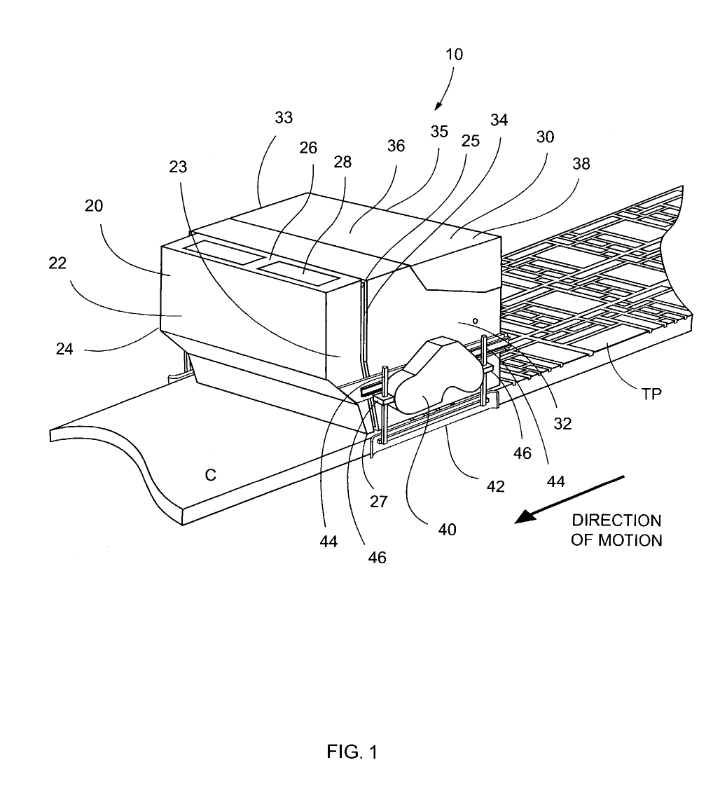

Referring now to FIG. 1, apparatus 10 is shown in operation. Apparatus 10 preferably travels along plastic concrete surface C and preferably applies textured pattern TP thereto. Apparatus 10 preferably has front container 20 having preferably front 22, first side 23, second side 24, back 25, top 26, and bottom 27, wherein front 22, first side 23, second side 24, back 25, top 26 and bottom 27 preferably enclose front container 20 for preferably holding release agent, as more fully described below. Top 26 of front container 20 preferably has located thereon, doors 28 openable for loading of release agent. Front container 20 preferably serves as the lead portion of apparatus 10 when apparatus 10 is in motion.

Rear section 30 of apparatus 10 preferably has therein first side 32, second side 33, front 34, back 35 and top 36 which together preferably contain the mechanical portions of apparatus 10. Top 36 preferably has located therein door panel 38 preferably hinged for access to the mechanical portions of apparatus 10.

Preferably located on first side 32 of apparatus 10 is drive assembly 40. Drive assembly 40 preferably has screed plate 42 attached thereto via arms 44, which are preferably secured by locking devices 46. Screed plate 42 is preferably height adjusted by moving arms 44 which are preferably held within locking devices 46, wherein locking devices 46 preferably secure arms 44 in a desired position. Screed plate 42 serves to guide apparatus 10 along its intended path. Similarly located on second side 33, is a corresponding screed plate 42 to facilitate guidance of apparatus 10.

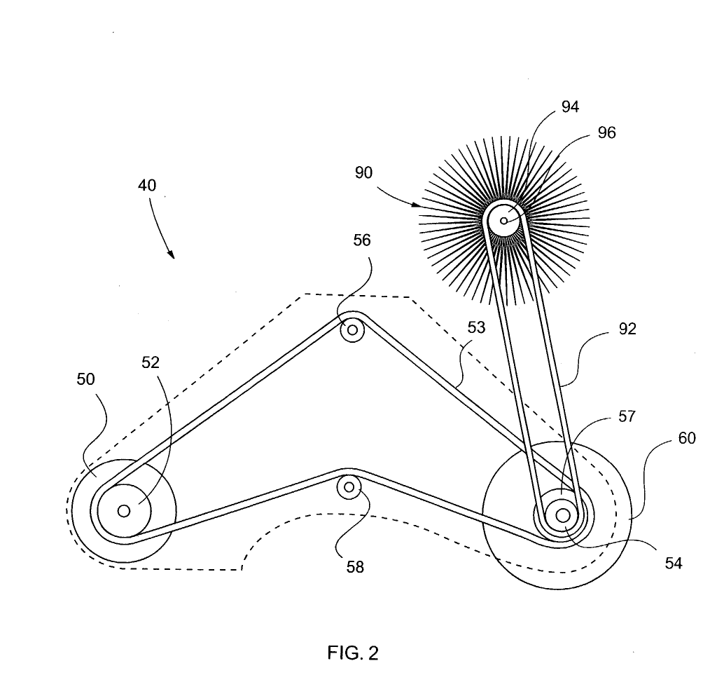

Referring now to FIG. 2, extension 52 of drive roller 50 is preferably located within drive assembly 40 at the anterior portion thereof. Belt 53 preferably travels sequentially over motor shaft roller 57, idler roller 56, extension 52, idler roller 58, and then returns to motor shaft roller 57. When motor 60 is operated, it causes belt 53 to move in its designated path, wherein belt 53 preferably turns extension 52, thus turning drive roller 50 and setting apparatus 10 into motion.

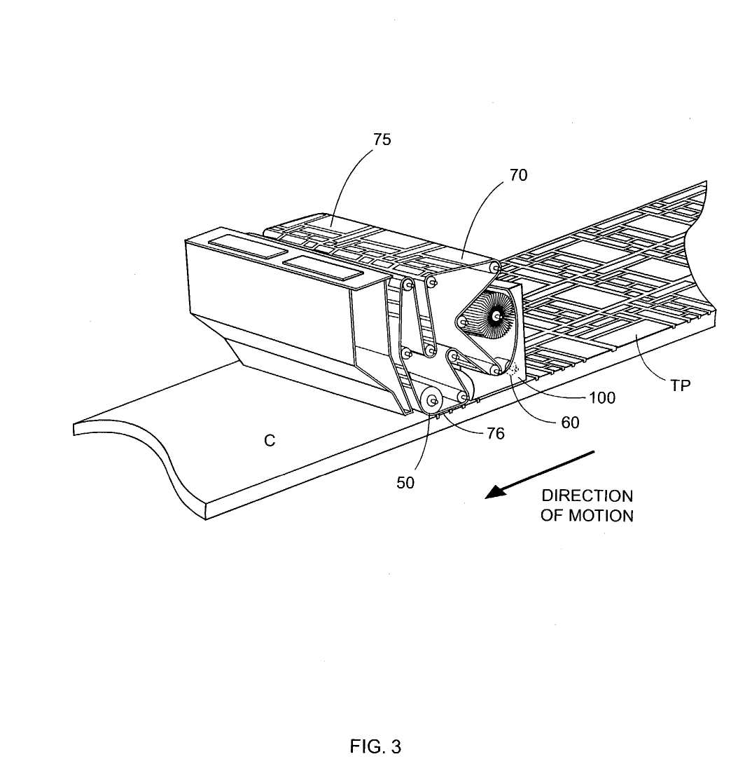

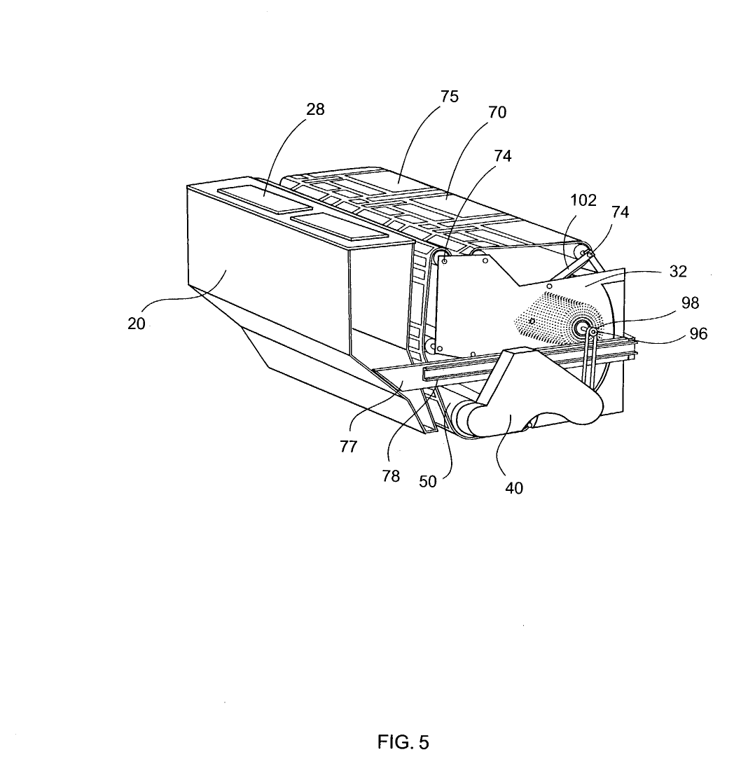

Referring now to FIGS. 2 and 3 brush 90 is preferably powered by belt 92, wherein belt 92 preferably travels over motor shaft roller extension 54 and brush drive roller 94. Brush spindle 96 is preferably held within suitable bearings 98 (see FIG. 5). As motor 60 rotates, brush 90 preferably rotates and removes any residual concrete picked up by belt 70, preferably brushing the residual concrete off into reclamation chamber 100 where it may be discarded or recycled.

Turning now to FIGS. 3, 4A, 4B and 5, as drive roller 50 rotates, it preferably turns belt 70, wherein belt 70 is preferably festooned across its internal idler rollers 72a, 72b, 72c, 72d, 72e, 72f, 72g, 72h and 72i, thus preferably causing it to move over idler rollers 72a, 72b, 72c, 72d, 72e, 72f, 72g, 72h and 72i, preferably in sequence. Idler rollers 72a, 72b, 72c, 72d, 72f, 72g, 72h and 72i are supported in bearings 74 attached to first side 32 and second side 33. Trailing idler roller 72e is supported by arm 102 having bearing 74 therein. Belt 70 preferably has pattern 75 embossed thereon. As belt 70 moves, apparatus 10 preferably travels along concrete C, preferably impressing pattern TP thereon via pressure from the weight of apparatus 10 bearing on belt 70 at location 76.

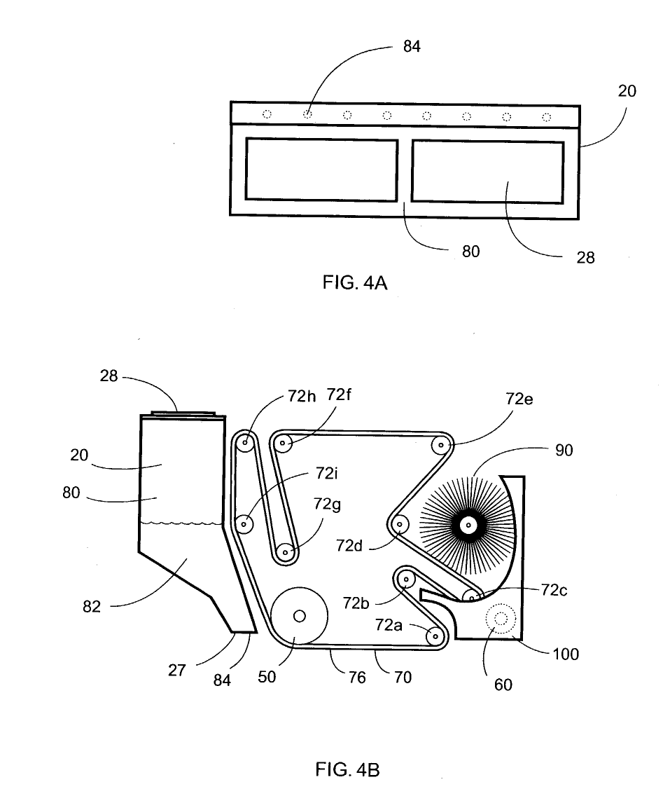

Turning now to FIGS. 4A and 4B, front tank 20 preferably has chamber 80 located therein. Chamber 80 preferably serves to carry release agent 82, which is loaded through doors 28. Release agent 82 preferably is applied to concrete C by preferably dripping through holes 84 in bottom 27 of front container 20. Release agent 82 preferably facilitates belt 70 lifting off of concrete C after pattern TP has been imparted thereto, preferably reducing the amount of residual concrete that adheres to belt 70.

Referring now to FIG. 5, drive assembly 40 is preferably fixably attached to frame rail 78, which is itself preferably fixably attached to first side 32 of apparatus 10 via support frame 77. Support frame 77 is fixably attached to first side 32. First side 32 further has bearings 74 and 98 located therein. Support frame 77 is further fixably attached to front container 20 on fist side 23, thus supporting front container rigidly to rear section 30 of apparatus 10. Similarly disposed on second side 33 is a corresponding support frame 77 (not shown).

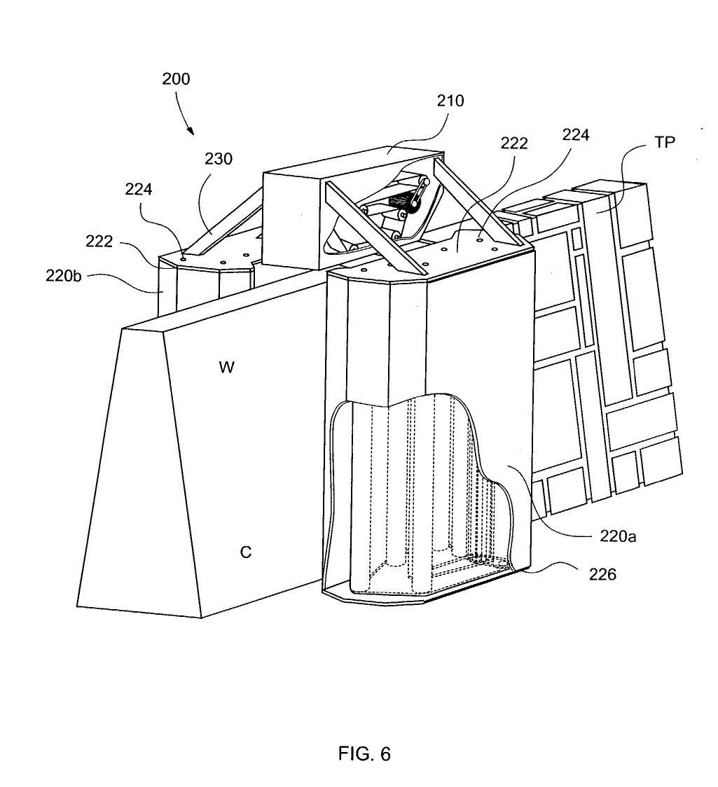

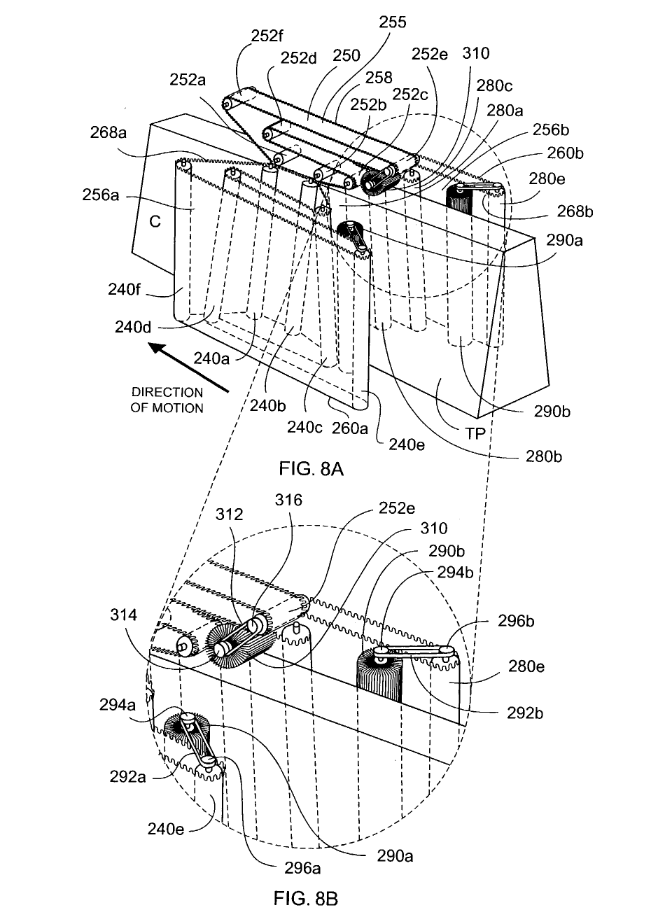

Referring now to FIGS. 6, 7, 8A and 8B, wherein an alternative embodiment of the present invention is shown, apparatus 200 is a larger variation of apparatus 10, wherein three engines 210, 220a, and 220b, similar in function to apparatus 10, are ganged together to form apparatus 200. Apparatus 200 has top engine 210 and side engines 220a and 220b. Top engine 210 is supported by riser supports 230. Apparatus 200 is suitable for imparting a textured pattern TP to wall formations W of concrete C. In this embodiment, apparatus 200 is powered by external force, such as by manpower. When powered by external force, belts 250, 260a and 260b are in frictional contact with concrete C. As apparatus 200 is moved, belt 250 is restricted by friction and thus causes rotation of idler rollers 252a, 252b, 252c, 252d, 252e and 252f. As apparatus 200 is moved, belt 260a is restricted by friction and thus causes rotation of idler rollers 240a, 240b, 240c, 240d, 240e and 240f. As apparatus 200 is moved, belt 260b is restricted by friction and thus causes rotation of idler rollers 280a, 280b, 280c (not visible in FIGS. 8A and 8B), 280d, 280e (not visible in FIGS. 8A and 8B) and 280f. Brushes 310, 290a and 290b are driven by belts 312, 292a and 292b, respectively, via brush roller extensions 314, 294a and 294b, respectively, and idler roller extensions 316, 296a and 296b, respectively. Rotation of belts 250, 260a and 260b results in rotation of respective idler rollers 252d, 240d and 280d, and idler roller extensions 316, 296a and 296b. Idler roller extensions 316, 296a and 296b rotate with respective idler rollers 252d, 240d and 280d, thus rotating belts 312, 292a and 292b. Belts 312, 292a and 292b further rotate brush roller extensions 314, 294a and 294b, respectively, thus rotating brushes 310, 290a and 290b, respectively. Brushes 310, 290a and 290b are in contact with belts 250, 260a and 260b, respectively, and remove excess debris via their rotation. It is further contemplated that apparatus 200 may also be powered internally, such as, for exemplary purposes only, by a motor.

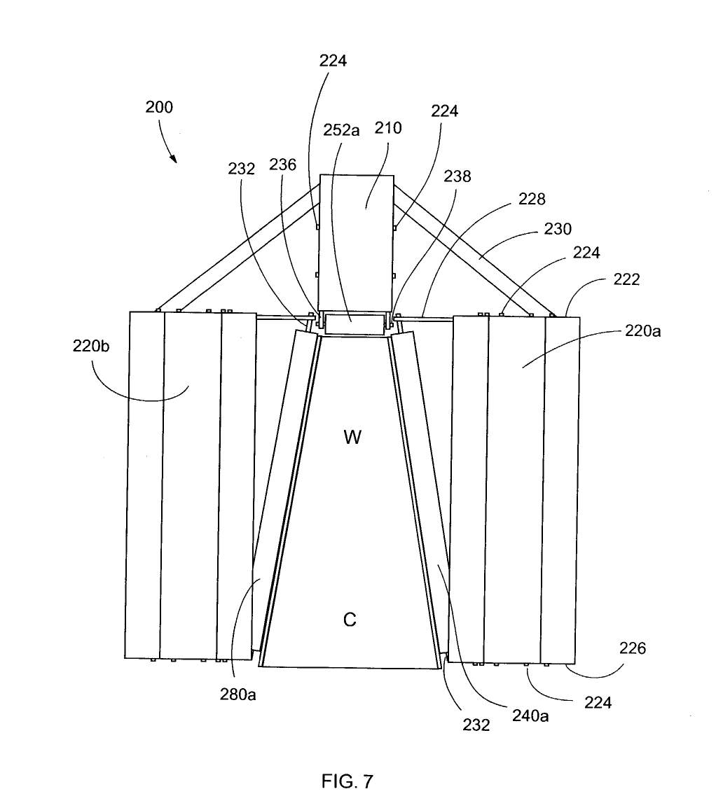

Referring now to FIG. 7, apparatus 200 is shown from the front, viewed in the direction of travel. Top engine 210 of apparatus 200 is supported by riser supports 230 attached to side of top engine 210 and to top of side engines 220a and 220b. In this view, belts 250, 260a and 260b have been removed for clarity. Rollers 252a, 240a and 280a are shown in this view. Roller 252a rests on the top of the workpiece, wall W. Rollers 240a and 280a incline to the shape of wall W. Behind rollers 240a and 280a are rollers 240b and 280b, hidden from view by rollers 240a and 280a. Rollers 240b and 280b also incline to the shape of wall W.

Turning now to FIGS. 6, 8A and 8B, top engine 210 has belt 250 having a pattern 255 embossed thereon suitable for creating a textured pattern TP. Side engine 220a has thereon belt 260a having a pattern 256a embossed thereon suitable for applying a textured pattern TP complementary to that applied by top engine 210. Belt 250 engages belt 260a by means of toothed edges 258 that interlock with toothed edges 268a of belt 260a to synchronize the motion of the two belts 250 and 260a. Side engine 220b has thereon belt 260b having a pattern 256b embossed thereon suitable for applying a textured pattern complementary to that applied by top engine 210. Belt 250 engages belt 260b by means of toothed edges 258 that interlock with toothed edges 268a of belt 260a to synchronize the motion of the two belts 250 and 260b. Thus belts 250, 260a and 260b rotate in unison with a synchronized pattern when engines 210, 220a and 220b are moved. By interlocking belts 250, 260a and 260b, the pattern on the belts registers correctly and is applied as planned. Belt 260a is held in place at an appropriate angle to wall W by rollers 240a and 240b, wherein rollers 240a and 240b are tilted to conform to the slope of wall W. Belt 260b is also held in place at an appropriate angle to wall W, in this instance by rollers 280a and 280b, which are slanted to conform to the angle of incline of wall W.

Belt 250 of top engine 210 festoons over idler rollers 252a, 252b, 252c, 252d, 252e, and 252f, wherein belt 250 has a pattern 255 embossed thereon as detailed above. Belt 250 further has toothed edges 258 that interlock with toothed edges 268a and 268b of belts 260a and 260b, respectively, thus causing belt 260a to move across respective rollers 240a, 240b, 240c, 240d, 240e and 240f and belt 260b to move across respective rollers 280a, 280b, 280c (not visible in FIGS. 8A and 8B), 280d, 280e (not visible in FIGS. 8A and 8B) and 280f. Brush 310 serves to clean residual material from belt 250.

Belt 260a is festooned across idler rollers 240a, 240b, 240c, 240d, 240e, and 240f. Between idler rollers 240a and 240b, belt 260a rests against a work surface, thus imparting an embossed pattern 256a onto the work surface. In order to compensate for the angle of idler rollers 240a and 240b, idler rollers 240e and 240f are angled, thus keeping edges of belt 260a travelling an equal distance as belt 260a passes over idler rollers 240a, 240b, 240c, 240d, 240e, and 240f. Belt 260a engages teeth 258 of belt 250 via teeth 268a on belt 260a. Brush 290a serves to clean residual material off of belt 260a.

Belt 260b is festooned across idler rollers 280a, 280b, 280c (not visible in FIGS. 8A and 8B), 280d, 280e (not visible in FIGS. 8A and 8B) and 280f. Between idler rollers 280a and 280b, belt 260b rests against a work surface and imparts a pattern 256b thereto. In order to compensate for the angle of idler rollers 240a and 240b, idler rollers 240e and 240f are angled, thus keeping edges of belt 260a travelling an equal distance as belt 260b passes over idler rollers 280a, 280b, 280c, 280d, 280e and 280f. Belt 260b engages teeth 258 of belt 250 via teeth 268b on belt 260b. Brush 290b serves to clean residual material off of belt 260b.

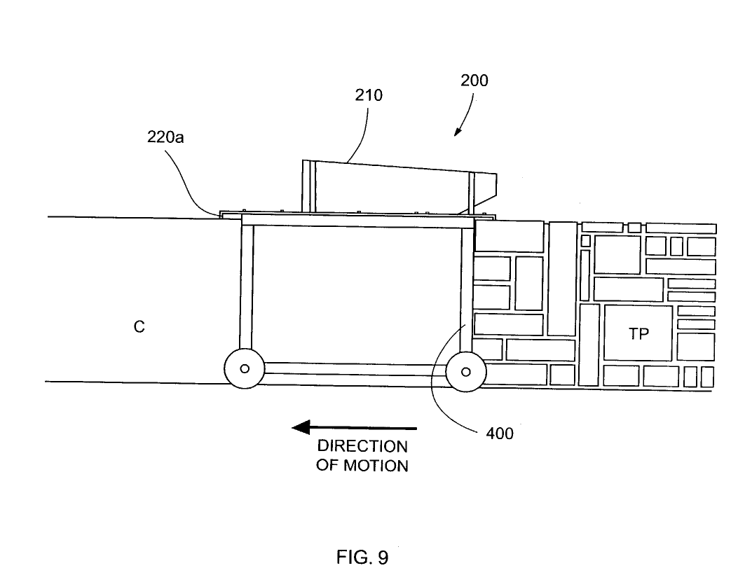

As shown in FIG. 9, it is contemplated in yet a further alternative embodiment that apparatus 200 could have top engine 210 and side engine 220a, but would replace side engine 220b with support rolling means 400, and would thus be suitable for imparting a pattern to the top and one side of a wall.

It is envisioned in an alternative embodiment that a plurality of belts may be contained within a device for embossing vertical as well as horizontal surfaces.

In yet another alternative embodiment, it is contemplated that a device according to the preferred and/or alternative embodiments of the present invention could be carried by a paving machine, such as, for exemplary purposes only, underneath such a paving machine, to apply a pattern to the paving material that the paving machine has just laid down. In such an application, the present invention may be powered by the paving machine using hydraulic or other power means, or could rely on the friction of the belt with the work surface to move the belt as the paving machine moves forward.

It is contemplated in yet another alternative embodiment that the present invention could be made as an unpowered device that is manually propelled and guided.

It is contemplated in yet still another alternative embodiment that two separate main texturing belts could each have their own drive assembly 40 on sides 32 and 33 of apparatus 10. The motors 60 of the separate drive assemblies 40 could then be rotated at different rates, driving their belts at different rates, causing the separate drive belts to be rotated at different rates, and thus allow apparatus 10 to negotiate curves while applying texture pattern TP to concrete C.

Having thus described exemplary embodiments of the present invention, it should be noted by those skilled in the art that the within disclosures are exemplary only, and that various other alternatives, adaptations, and modifications may be made within the scope of the present invention. Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation. Accordingly, the present invention is not limited to the specific embodiments illustrated herein, but is limited only by the following claims.

What is claimed is:

1. A machine for embossing surfaces, said machine comprising:
at least one belt having a pattern thereon; and
plurality of rollers over which said belt rides.

2. The machine of claim 1, wherein said at least one belt is festooned across said plurality of rollers.

3. The machine of claim 1, further comprising at least one driven roller, wherein said at least one belt is moved by rotation of said at least one driven roller.

4. The machine of claim 1, further comprising means for guiding said machine.

5. The machine of claim 4, wherein said means for guiding comprises a screed plate.

6. The machine of claim 1, further comprising means for propelling said machine.

7. The machine of claim 1, wherein said at least one belt has a length greater than a predetermined length of surface to be embossed, to provide the appearance of a non-repeating pattern on the surface.

8. The machine of claim 2, wherein said at least one belt has a length of at least approximately twenty feet.

9. The machine of claim 6, wherein said means for propelling comprises a motor.

10. The machine of claim 6, wherein said means for propelling is an external means.

11. The machine of claim 10, wherein said means for propelling is manually applied force.

12. The machine of claim 6, wherein said machine is carried by a parent apparatus.

13. The machine of claim 12, wherein said parent apparatus is a paving machine.

14. The machine of claim 12, wherein said means for propelling is located on said parent apparatus.

15. The machine of claim 1, further comprising a means for brushing to remove debris from said at least one belt.

16. The machine of claim 15, wherein said means for brushing comprises a rotating brush.

17. The machine of claim 1, further comprising a means for providing release agent.

18. The machine of claim 17, wherein said means for applying release agent comprises a tank with holes in the bottom thereof.

19. The machine of claim 2, wherein said plurality of rollers comprises at least six rollers.

20. A method for embossing surfaces, comprising the steps of:
a. obtaining at least one device comprising at least one belt and a plurality of rollers, wherein said at least one belt has a pattern thereon; and
b. moving said at least one device over a surface to emboss a pattern thereon.

21. The method of claim 20, wherein said at least one belt is festooned across said plurality of rollers.

22. The method of claim 20, further comprising the step of providing propulsion means.

23. The method of claim 22, wherein said propulsion means is a motor.

24. The method of claim 22, further comprising the step of providing a housing for said at least one belt, said rollers and said propulsion means;

25. The method of claim 21, wherein said at least one belt is at least approximately twenty feet long.

26. The method of claim 22, wherein said propulsion means is located on a parent device.

27. The method of claim 26, wherein said parent device is a paving machine.

28. The method of claim 20, further including an additional step, after the step of obtaining at least one device comprising at least one belt, of providing a means for brushing said at least one belt.

29. The method of claim 28, wherein said means for brushing comprises a rotating brush.

30. A device for embossing surfaces, said device comprising plurality of engines, each of said plurality of engines having at least one belt thereon, with each of said belts having a pattern thereon.

31. The device of claim 30, wherein said belts are festooned across rollers.

32. The device for embossing surfaces of claim 30, wherein a portion of said belts are proximate one another.

33. The device for embossing surfaces of claim 32, wherein said belts further comprise interlocking connections between said portions of said belts.

34. The device for embossing surfaces of claim 30, further comprising means for driving said belts.

35. The device for embossing surfaces of claim 34, wherein said means for driving said belts comprises a motor-powered roller.
